(19) United States
(12) Patent Application Publication
(10) Pub. No.: US 2026/0132752 A1
(43) Pub. Date: May 14, 2026

(54) CONTROL DEVICE FOR VEHICLE

(71) Applicant: TOYOTA JIDOSHA KABUSHIKI KAISHA, Toyota-shi (JP)

(72) Inventor: Shinya Ohori, Miyoshi-shi (JP)

(73) Assignee: TOYOTA JIDOSHA KABUSHIKI KAISHA, Toyota-shi (JP)

(21) Appl. No.: 19/283,905

(22) Filed: Jul. 29, 2025

(30) Foreign Application Priority Data
Nov. 14, 2024 (JP) 2024-199071

(51) Int. Cl. F02D 41/06; F02D 41/40; F02P 5/15

(52) U.S. Cl. CPC F02D 41/062; F02D 41/401; F02P 5/1506

(57) ABSTRACT

The control device is applied to a vehicle that transmits torque output from an internal combustion engine to drive wheels. The control device includes a processing circuit for controlling the internal combustion engine. The processing circuit executes ignition timing control, automatic stop control, and automatic start control. The ignition timing control is a control for repeating the adjustment of the ignition timing in accordance with the detection result of the knocking starting from the initial ignition timing at the engine start. The processing circuit terminates the ignition timing control when the engine rotational speed becomes equal to or lower than the first rotational speed greater than “0”.

### CROSS-REFERENCE TO RELATED APPLICATION

This application claims priority to Japanese Patent Application No. 2024-199071 filed on Nov. 14, 2024. The disclosure of the above-identified application, including the specification, drawings, and claims, is incorporated by reference herein in its entirety.

### BACKGROUND

### 1. Technical Field

The present disclosure relates to a control device for a vehicle.

### 2. Description of Related Art

Japanese Unexamined Patent Application Publication No. 2018-155224 (JP 2018-155224 A) discloses a control device that executes control for automatically stopping the operation of an internal combustion engine by stopping fuel supply when a predetermined stop condition is satisfied. Further, the control device disclosed in the above-mentioned document is disclosed to execute control for restarting the internal combustion engine when a predetermined start condition is satisfied after executing the above control.

The control device suppresses vibration of a vehicle body generated when the internal combustion engine is restarted by executing control for retarding the ignition timing when the internal combustion engine is restarted.

### SUMMARY

In order to execute the control for retarding the ignition timing when the internal combustion engine is restarted, it is necessary to determine that the internal combustion engine has stopped and start ignition timing control in a state in which the ignition timing is retarded when restarting the internal combustion engine. When the engine rotation speed of the internal combustion engine being brought to “0” is used as a condition for determining that the internal combustion engine has stopped, the following issue arises.

When a request to restart the internal combustion engine is generated before the engine rotation speed of the internal combustion engine becomes “0”, control for retarding the ignition timing is not executed. When the internal combustion engine is restarted without executing the control for retarding the ignition timing, there is a possibility that vibration of the vehicle body generated when the internal combustion engine is restarted cannot be suppressed.

In order to address the above issue, an aspect provides a control device for a vehicle that includes an internal combustion engine and that transmits torque output from the internal combustion engine to drive wheels, and the control device is applied to the vehicle. The control device includes a processing circuit that controls the internal combustion engine. The processing circuit executes ignition timing control that is started with an initial ignition timing at start of the internal combustion engine and in which an ignition timing is repeatedly adjusted according to a result of detecting knocking, the ignition timing control advancing the ignition timing while knocking is not detected and retarding the ignition timing when knocking is detected. The processing circuit executes automatic stop control for stopping fuel injection from a fuel injection valve when an automatic stop request is generated during operation of the internal combustion engine, and automatic start control for resuming the fuel injection from the fuel injection valve and causing the internal combustion engine to operate when a restart request is generated while the fuel injection is stopped by the automatic stop control. The processing circuit ends the ignition timing control when an engine rotation speed becomes equal to or lower than a first rotation speed that is more than “0”.

The control device for a vehicle can suppress vibration of the vehicle body generated when the internal combustion engine is restarted even when a restart request is generated before the engine rotation speed of the internal combustion engine becomes “0”.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a control device according to an embodiment and an internal combustion engine of a vehicle to which the control device is applied;

FIG. 2 is a flowchart showing a flow of a series of processes for determining whether or not the processing circuit shown in FIG. 1 ends the ignition timing control;

FIG. 3 is a flowchart showing a flow of a series of processes for determining whether or not the processing circuit shown in FIG. 1 maintains an ignition timing at an initial ignition timing;

FIG. 4 is a timing chart of a comparative example. The following timing charts are shown in order from the top: transition of fuel cut flag, transition of fuel injection quantity, transition of engine revolution speed, transition of ignition timing delay angle history flag, and transition of ignition timing; and

FIG. 5 is a timing chart showing the operation of the processing circuit shown in FIG. 1. From the top, the transition of the fuel cut flag, the transition of the fuel injection amount, the transition of the engine rotational speed, the transition of the ignition timing retard angle history flag, the transition of the ignition timing, the transition of the ignition frequency is a timing chart showing, respectively.

### DETAILED DESCRIPTION OF EMBODIMENTS

Configuration of Vehicle 1 to which Control Device 100 is Applied

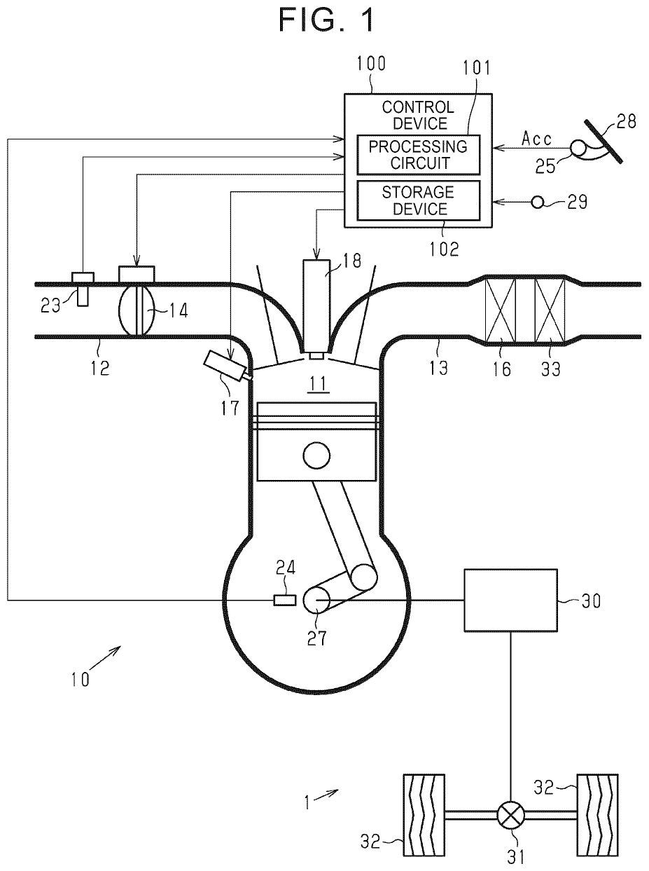

Hereinafter, an embodiment of a control device for a vehicle will be described with reference to FIGS. 1 to 5. As illustrated in FIG. 1, the control device 100 of the present embodiment includes a processing circuit 101 that executes a program and executes various processes, and a storage device 102 in which the program is stored. The processing circuit 101 includes a processor. The storage device 102 can store various types of data. The vehicle 1 to which the control device 100 is applied includes an internal combustion engine 10, a transmission device 30, a differential device 31, and a plurality of drive wheels 32. The torque output from the internal combustion engine 10 is transmitted to the plurality of drive wheels 32 via the transmission device 30 and the differential device 31.

The internal combustion engine 10 includes a combustion chamber 11 that burns an air-fuel mixture, an intake passage 12 that serves as an introduction passage for air to the combustion chamber 11, and an exhaust passage 13 that serves as an exhaust passage for exhaust gas from the combustion chamber 11. The intake passage 12 is provided with a throttle valve 14, which is a valve for adjusting the amount of intake air. The exhaust passage 13 is provided with a catalytic converter 16 that oxidizes HC and CO in the exhaust gas and reduces NOx. A filter 33 for collecting fine particles contained in the exhaust gas is provided on the exhaust downstream side of the catalytic converter 16. The internal combustion engine 10 includes a fuel injection valve 17 that injects and supplies fuel into air used for combustion in the combustion chamber 11 to form an air-fuel mixture. The internal combustion engine 10 includes an ignition device 18 that ignites the air-fuel mixture in the combustion chamber 11 by spark discharge.

The processing circuit 101 of the control device 100 controls the internal combustion engine 10. The control device 100 receives detection signals of the air flow meter 23, the crank angle sensor 24, the accelerator pedal sensor 25, and the knock sensor 29. The air flow meter 23 is a sensor that detects an amount of intake air. The intake air amount represents a flow rate of the air flowing into the combustion chamber 11 through the intake passage 12. The crank angle sensor 24 is a sensor that detects a crank angle. The crank angle represents a rotation angle of the crankshaft 27, which is an output shaft of the internal combustion engine 10. The processing circuit 101 obtains the engine rotational speed NE of the internal combustion engine 10 based on the crank angle. The accelerator pedal sensor 25 is a sensor that detects the accelerator pedal opening Acc. The accelerator pedal opening Acc represents the amount of depression of the accelerator pedal 28 by the driver. The knock sensor 29 is a sensor that detects knock information for detecting whether knocking has occurred in the internal combustion engine 10.

The processing circuit 101 determines an operation amount of the internal combustion engine 10, such as a throttle opening degree, a fuel injection amount, and an ignition timing, based on a detection signal of each sensor. The processing circuit 101 controls the internal combustion engine 10 by operating the actuators of the internal combustion engine 10 such as the throttle valve 14, the fuel injection valve 17, and the ignition device 18 based on the determined operation amount. For example, the processing circuit 101 calculates the required output Pe based on the accelerator pedal opening Ace and the like. The required output Pe represents the output of the internal combustion engine 10 required to generate the driving force of the vehicle 1 required by the driver through the operation of the accelerator pedal 28. The processing circuit 101 controls the throttle valve 14, the fuel injection valve 17, and the ignition device 18 according to the required output Pe.

The processing circuit 101 executes ignition timing control. The ignition timing control is a control for repeatedly adjusting the ignition timing in accordance with a detection result of knocking by the knock sensor 29. The processing circuit 101 gradually advances the ignition timing while knocking is not detected. The processing circuit 101 retards the ignition timing when knocking is detected. The ignition timing control is started from the initial ignition timing when the engine is started. The initial ignition timing is set to, for example, the most retarded value within the set range of the ignition timing. The initial ignition timing may be set to a value other than the most retarded angle value. However, from the viewpoint of suppressing the vibration of the vehicle 1 at the time of starting the engine, it is desirable that the initial ignition timing is set on the retard side of the ignition timing during the steady operation other than the time of starting.

The processing circuit 101 executes automatic stop control. The automatic stop control is a control for stopping fuel injection from the fuel injection valve 17 when an automatic stop request is generated during operation of the internal combustion engine 10. The auto-stop request is generated, for example, when the required output Pe to the internal combustion engine 10 becomes “0”. The required output Pe becomes “0” when the accelerator pedal opening Acc becomes “0”. When the auto-stop is requested, the processing circuit 101 sets the fuel-cut flag to “ON”. While the fuel cut flag is set to “ON”, the processing circuit 101 causes the fuel injection valve 17 to stop fuel injection.

The processing circuit 101 executes automatic start control. The automatic start control is a control for restarting the fuel injection from the fuel injection valve 17 to operate the internal combustion engine 10 when a restart request is generated while the fuel injection is stopped by the automatic stop control. The restart request is generated, for example, when the required output Pe to the internal combustion engine 10 is greater than “0” from the “0” state. An example in which the required output Pe is greater than “0” from a state of “0” is an example in which the accelerator pedal opening Acc becomes greater than “0” from “0” by operating the accelerator pedal 28 of the driver. The restart request is generated, for example, when the prospective depression of the brake pedal is released from a state in which the vehicle is stopped by depressing the brake pedal. When a restart request is generated, the processing circuit 101 resets the fuel-cut flag to “OFF”. While the fuel cut flag is reset to “OFF”, the processing circuit 101 causes the fuel injection valve 17 to perform fuel injection. When cranking is required to restart the internal combustion engine 10 when a restart request is generated, cranking by a motor may be performed.

### Processing for Determining Whether to End Ignition Timing Control

The processing circuit 101 terminates the ignition timing control when the engine rotational speed NE becomes equal to or lower than the first rotational speed NE1 greater than “0”. The processing circuit 101 repeatedly executes a series of processing for determining whether or not to end the ignition timing control during the operation of the internal combustion engine 10.

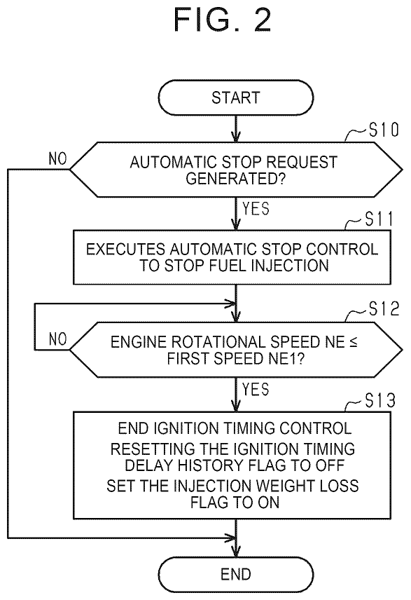

As shown in FIG. 2, when this series of processes is started, in S10 process, the processing circuit 101 determines whether or not an auto-stop-request has occurred. When the auto-stop is requested (S10: YES), the processing circuit 101 advances the processing to S11. When the auto-stop request is not generated (S10:NO), the processing circuit 101 ends the series of processing illustrated in FIG. 2 without performing the subsequent processing.

In S11 process, the processing circuit 101 executes an auto-stop control for stopping fuel injection from the fuel injection valve 17. Thereafter, the processing circuit 101 advances the processing to S12.

In S12 process, the processing circuit 101 determines whether or not the engine rotational speed NE is equal to or less than the first rotational speed NE1. When the engine rotational speed NE is equal to or lower than the first rotational speed NE1 (S12: YES), the processing circuit 101 advances the processing to S13. When the engine rotational speed NE is greater than the first rotational speed NE1 (S12: NO), the processing circuit 101 executes the processing of the repetitive S12 while the auto-stop control is executed.

In S13 process, the processing circuit 101 terminates the ignition timing control. Thereafter, the processing circuit 101 ends the series of processing illustrated in FIG. 2.

In S13 process, the processing circuit 101 resets the ignition timing retard history flag to “OFF”. The ignition timing retard history flag is a flag indicating whether or not control for setting the ignition timing to the initial ignition timing and control for maintaining the ignition timing to the initial ignition timing are executed at the engine start. The fact that the ignition timing retard angle history flag is “ON” indicates that the control for setting the ignition timing to the initial ignition timing and the control for maintaining the ignition timing to the initial ignition timing are executed at the engine start. The fact that the ignition timing retard angle history flag is “OFF” indicates that the control for setting the ignition timing to the initial ignition timing and the control for maintaining the ignition timing to the initial ignition timing are not executed at the engine start.

In S13 process, the processing circuit 101 sets the injection weight loss flag to “ON”. The injection amount reduction flag is a flag indicating whether or not to reduce and correct the amount of fuel injection from the fuel injection valve 17. When the injection amount reduction flag is “ON”, the processing circuit 101 executes control for reducing and correcting the amount of fuel injection. When the engine rotational speed NE is equal to or less than the first rotational speed NE1 (S12: YES), the processing circuit 101 sets the injection amount reduction flag to “ON”. That is, the processing circuit 101 executes control for reducing and correcting the fuel injection amount when the fuel injection is restarted on condition that the engine rotational speed NE becomes equal to or lower than the first rotational speed NE1. When the injection amount reduction flag is “OFF”, the processing circuit 101 does not execute control for reducing and correcting the amount of fuel injection.

### Control to Maintain Ignition Timing at Initial Ignition Timing

The processing circuit 101 starts the ignition timing control by the automatic start control. At the start of the internal combustion engine 10, the processing circuit 101 executes a series of processes for determining whether to set the ignition timing to the initial ignition timing and whether to maintain the ignition timing at the initial ignition timing.

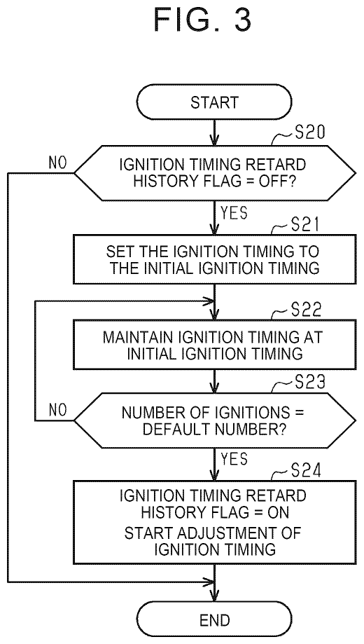

As shown in FIG. 3, when this series of processing is started, in S20 processing, the processing circuit 101 determines whether or not the ignition timing retardation history flag is “OFF”. When the ignition timing retard history flag is “OFF” (S20: YES), the processing circuit 101 advances the processing to S21. When the ignition timing retard flag is not “OFF”, that is, when the ignition timing retard flag is “ON” (S20:NO), the processing circuit 101 ends the series of processing illustrated in FIG. 3. When the ignition timing retard history flag is “ON”, the processing circuit 101 does not terminate the ignition timing control. Therefore, the processing circuit 101 continues the ignition timing control.

In S21 process, the processing circuit 101 sets the ignition timing to the initial ignition timing. Thereafter, the processing circuit 101 advances the processing to S22. In S22 process, the processing circuit 101 performs control to maintain the ignition timing at the initial ignition timing. Thereafter, the processing circuit 101 advances the processing to S23.

In S23 process, the processing circuit 101 determines whether the number of fires has reached a predetermined number. When the number of fires reaches the predetermined number (S23: YES), the processing circuit 101 advances the processing to S24. When the number of ignitions has not reached the predetermined number of times (S23: NO), the processing circuit 101 continues control to maintain the ignition timing at the initial ignition timing.

In S24 process, the processing circuit 101 sets the ignition timing retard history flag to “ON”. Then, the processing circuit 101 ends the control of maintaining the ignition timing at the initial ignition timing. As a result, the processing circuit 101 starts adjusting the ignition timing according to the detection result of the knocking through the ignition timing control. Thereafter, the processing circuit 101 ends the series of processing illustrated in FIG. 3. That is, when the ignition timing control is started by the automatic start control, the processing circuit 101 does not adjust the ignition timing until the number of ignitions reaches a predetermined number of times, thereby maintaining the ignition timing at the initial ignition timing.

When the control for maintaining the ignition timing at the initial ignition timing is completed, the processing circuit 101 ends the control for reducing and correcting the fuel injection amount. When the internal combustion engine 10 is restarted, a part of the injected fuel may adhere to the wall surface of the combustion chamber 11. For this reason, the processing circuit 101 executes control for increasing and correcting the fuel injection amount for a predetermined period after finishing the control for reducing and correcting the fuel injection amount at the time of restarting the internal combustion engine 10. It should be noted that the processing circuit 101 does not have to execute the control of increasing and correcting the fuel injection amount for a predetermined period even when the internal combustion engine 10 is restarted.

### Operation of this Embodiment

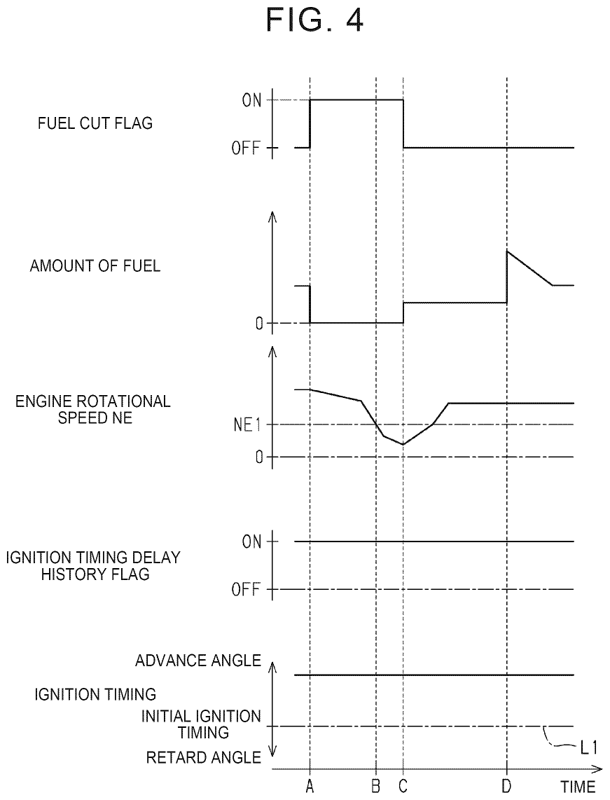

First, referring to the timing chart of the comparative example shown in FIG. 4, a problem that occurs when the processing circuit terminates the ignition timing control when the engine rotational speed NE becomes “0” will be described. The solid line in the top graph of FIG. 4 indicates the transition of the fuel cut flag. The solid line in the second graph from the top of FIG. 4 indicates the transition of the fuel injection amount. The solid line in the third chart from the top of FIG. 4 indicates the transition of the engine rotational speed NE. The solid line of the fourth graph from the top of FIG. 4 shows the transition of the ignition timing retardation history flag. The solid line of the fifth graph from the top of FIG. 4 shows the transition of the ignition timing. The dashed-dotted line L1 shown in the fifth chart from the top of FIG. 4 indicates the initial ignition timing.

As shown in FIG. 4, since the fuel cut flag is set to “OFF” prior to the time “A”, fuel injection from the fuel injection valve 17 is executed. At this time, the engine rotational speed NE is larger than the first rotational speed NE1. Further, the processing circuit of the comparative example performs the adjustment of the ignition timing.

The time “A” illustrated in FIG. 4 is the time at which the automatic stop request is generated. When an auto-stop is requested, the processing circuit of the comparative example sets the fuel-cut flag to “ON”. As a result, the fuel injection from the fuel injection valve 17 is stopped. As the injection is stopped, the engine rotational speed NE decreases. When the fuel cut flag is set to “OFF”, the processing circuit of the comparative example sets the injection amount reduction flag to “ON”.

The time “B” illustrated in FIG. 4 is a time at which the engine rotational speed NE has decreased to the first rotational speed NE1. At this time, since the engine rotational speed NE is not “0”, the processing circuit of the comparative example continues the ignition timing control. The ignition timing retard history flag remains “ON”. Thereafter, the engine rotational speed NE decreases until the time “C”.

The time “C” illustrated in FIG. 4 is the time at which the automatic start request is generated. At this time, the engine rotational speed NE is a speed greater than “0” and less than the first rotational speed NE1. When the auto-start is requested, the processing circuit of the comparative example sets the fuel-cut flag to “OFF”. As a result, fuel injection from the fuel injection valve 17 is started. At this time, since the injection amount reduction flag is set to “ON”, the fuel injection amount from the fuel injection valve 17 is reduced and corrected. On the other hand, since the ignition timing retard history flag is set to “ON”, the processing circuit of the comparative example continues to adjust the ignition timing.

The time “D” illustrated in FIG. 4 is a time at which the injection amount reduction flag is reset from “ON” to “OFF”. At this time, since the fuel injection amount from the fuel injection valve 17 is increased in a state in which the ignition timing is advanced, there is a possibility that a large acceleration suddenly occurs in the vehicle front-rear direction of the vehicle 1.

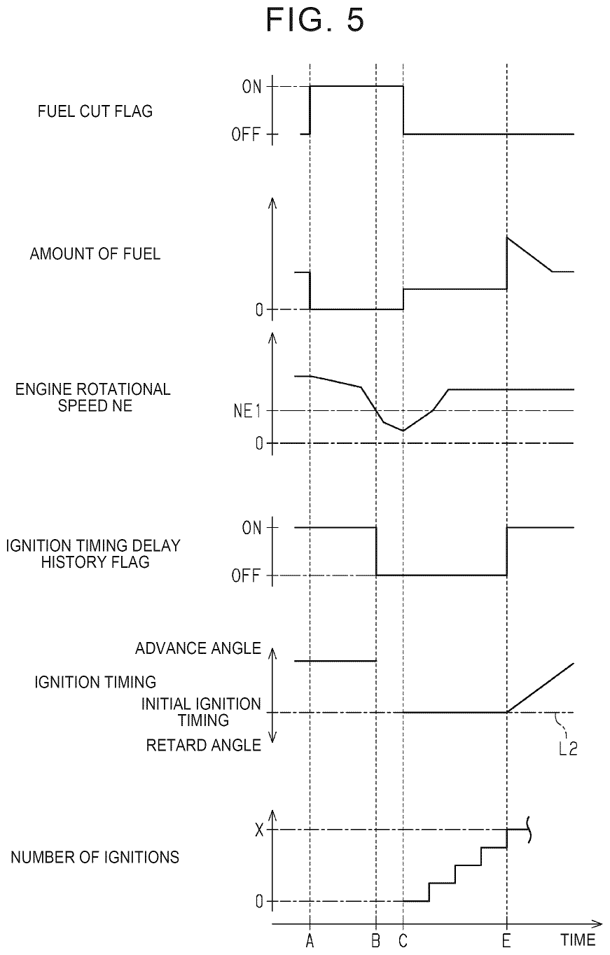

Next, referring to the timing chart shown in FIG. 5, an operation when the processing circuit 101 terminates the ignition timing control when the engine rotational speed NE becomes equal to or lower than the first rotational speed NE1 will be described. The solid line in the top graph of FIG. 5 indicates the transition of the fuel cut flag. The solid line in the second graph from the top of FIG. 5 indicates the transition of the fuel injection amount. The solid line in the third chart from the top of FIG. 5 indicates the transition of the engine rotational speed NE. The solid line of the fourth graph from the top of FIG. 5 shows the transition of the ignition timing retardation history flag. The solid line of the fifth graph from the top of FIG. 5 shows the transition of the ignition timing. The solid line in the bottom graph of FIG. 5 shows the transition of the number of ignitions. The dashed-dotted line L2 shown in the fifth chart from the top of FIG. 5 indicates the initial ignition timing.

As shown in FIG. 5, since the fuel cut flag is set to “OFF” prior to the time “A”, fuel injection from the fuel injection valve 17 is executed. At this time, the engine rotational speed NE is larger than the first rotational speed NE1. The processing circuit 101 adjusts the ignition timing.

The time “A” illustrated in FIG. 5 is the time at which the automatic stop request is generated, similarly to the time “A” illustrated in FIG. 4. When the auto-stop is requested, the processing circuit 101 sets the fuel-cut flag to “ON”. As a result, the fuel injection from the fuel injection valve 17 is stopped. As the injection is stopped, the engine rotational speed NE decreases.

The time “B” illustrated in FIG. 5 is a time at which the engine rotational speed NE has decreased to the first rotational speed NE1, similarly to the time “B” illustrated in FIG. 4. At this time, the processing circuit 101 terminates the ignition timing control and sets the ignition timing retard history flag to “OFF”. Further, the processing circuit 101 sets the injection weight loss flag to “ON”. Thereafter, the engine rotational speed NE decreases until the time “C”.

The time “C” illustrated in FIG. 5 is the time at which the automatic start request is generated, similarly to the time “C” illustrated in FIG. 4. At this time, the engine rotational speed NE is greater than “0” and has a speed less than the first rotational speed NE1. When the auto-start is requested, the processing circuit 101 sets the fuel-cut flag to “OFF”. As a result, fuel injection from the fuel injection valve 17 is started. At this time, since the injection amount reduction flag is set to “ON”, the fuel injection amount from the fuel injection valve 17 is reduced and corrected. Further, since the ignition timing retard history flag is reset to “OFF”, the ignition timing is maintained at the initial ignition timing. Thereafter, the processing circuit 101 controls the ignition device 18 to start ignition.

The time “E” illustrated in FIG. 5 is a time at which the number of ignitions is “X” times, which is a predetermined number of times. At this time, the processing circuit 101 sets the ignition timing retard history flag to “ON” and starts adjusting the ignition timing according to the detection result of knocking. Further, the processing circuit 101 sets the injection amount reduction flag to “OFF” to finish reducing the amount of fuel injection, and increases the amount of fuel injection for a predetermined period. Thereafter, the processing circuit 101 controls the internal combustion engine 10 according to the required output Pe.

When the engine rotational speed NE becomes equal to or lower than the first rotational speed NE1, the processing circuit 101 terminates the ignition timing control. Therefore, the processing circuit 101 can restart the internal combustion engine 10 when a restart request is generated even before the engine rotational speed NE becomes “0” and after the engine rotational speed NE becomes equal to or lower than the first rotational speed NE1. More specifically, the processing circuit 101 can restart the internal combustion engine 10 in a state in which the ignition timing is retarded to the initial ignition timing.

### Effect of this Embodiment

(1) The control device 100 can suppress vibrations of the vehicle body when the internal combustion engine 10 is restarted even when a restart request is generated prior to the engine rotational speed NE of the internal combustion engine 10 becoming “0”.

(2) When the adjustment of the ignition timing according to the detection of the knocking is started immediately after the start of the ignition timing control, there is a possibility that the ignition timing continues to advance immediately after the start of the ignition timing control. When the ignition timing continues to advance immediately after the internal combustion engine 10 is restarted, the acceleration of the vehicle 1 may increase due to an increase in the engine output. When the ignition timing control is started by the automatic start control, the processing circuit 101 executes control to maintain the initial ignition timing without adjusting the ignition timing until the number of ignitions reaches a predetermined number. Therefore, the control device 100 can suppress an increase in the acceleration of the vehicle 1 that occurs immediately after the internal combustion engine 10 is restarted.

(3) When the automatic stop control is performed, since the throttle valve 14 is closed, the pressure in the combustion chamber 11 is lower than the atmospheric pressure. When the fuel injection from the fuel injection valve 17 is resumed in this state, the air-fuel ratio becomes rich. When the air-fuel ratio becomes rich, particulate matter in the exhaust gas may increase. The processing circuit 101 executes control for reducing and correcting the fuel injection amount when the fuel injection from the fuel injection valve 17 is resumed on condition that the engine rotational speed NE becomes equal to or lower than the first rotational speed NE1 by executing the auto-stop control. Thus, the control device 100 can suppress the air-fuel ratio becoming rich when the internal combustion engine 10 is restarted. Therefore, the control device 100 can suppress an increase in particulate matter in the exhaust gas when the internal combustion engine 10 is restarted.

(4) When the ignition timing control is started by the automatic start control, the processing circuit 101 performs control to maintain the ignition timing at the initial ignition timing by not adjusting the ignition timing until the number of ignitions reaches a predetermined number of times. The processing circuit 101 executes control for reducing and correcting the fuel injection amount when the fuel injection from the fuel injection valve 17 is resumed, on condition that the engine rotational speed NE becomes equal to or lower than the first rotational speed NE1 due to the execution of the auto-stop control. When the control for maintaining the ignition timing at the initial ignition timing is completed, the processing circuit 101 ends the control for reducing and correcting the fuel injection amount. When the control for maintaining the ignition timing at the initial ignition timing is completed before the reduction correction of the fuel injection amount is completed, there is a possibility that the fuel injection amount increases in a state where the ignition timing is advanced. In this case, an increase in the output of the internal combustion engine 10 due to an increase in the fuel injection amount becomes particularly remarkable. As a result, as in the comparative example, a large acceleration may suddenly occur. According to the control device 100, an increase in the fuel injection amount does not occur in a state in which the ignition timing is advanced. Therefore, the control device 100 can suppress a situation in which a large acceleration suddenly occurs in the vehicle front-rear direction of the vehicle 1 due to an increase in the fuel injection amount in a state in which the ignition timing is advanced.

### Alternative Embodiment

The present embodiment can be modified and implemented as follows. The present embodiment and the following modification examples of the present embodiment can be combined with each other to the extent that they are not technically contradictory.

When the internal combustion engine 10 is restarted in a state in which the ignition timing is retarded to the initial ignition timing, the processing circuit 101 may terminate the control of reducing and correcting the fuel injection amount before the control of maintaining the ignition timing at the initial ignition timing is terminated. Even in this case, the control device 100 can reduce the acceleration in the vehicle front-rear direction that occurs when the internal combustion engine 10 is restarted.

When the processing circuit 101 restarts the internal combustion engine 10 in a state in which the ignition timing is retarded from the initial ignition timing, it is not necessary to execute control for maintaining the ignition timing at the initial ignition timing. Even in this case, the control device 100 can reduce the acceleration in the vehicle front-rear direction that occurs immediately after the restart of the internal combustion engine 10.

The processing circuit 101 may perform the control of reducing and correcting the fuel-injection amount except that the engine rotational speed NE becomes equal to or lower than the first rotational speed NE1. For example, the processing circuit 101 may execute a process of reducing and correcting the fuel injection amount on condition that a restart request has occurred.

The processing circuit 101 may not execute the control for reducing and correcting the fuel injection amount. The control device 100 may be configured as a circuitry including one or more processors that execute various processes in accordance with a computer program (software). Note that the control device 100 may be configured as a circuit including one or more dedicated hardware circuits such as an application-specific integrated circuit (ASIC) that executes at least some of the various processes, or a combination thereof. The processor includes a central processing unit (CPU) and a memory such as a random access memory (RAM) and a read only memory (ROM). The memory stores a program code or a command configured to cause the CPU to execute the process. Memory or computer readable media includes any available media that can be accessed by a general purpose or special purpose computer.

What is claimed is:

1. A control device for a vehicle that includes an internal combustion engine and that transmits torque output from the internal combustion engine to drive wheels, the control device being applied to the vehicle, and the control device comprising a processing circuit that controls the internal combustion engine, wherein:
the processing circuit executes
ignition timing control that is started with an initial ignition timing at start of the internal combustion engine and in which an ignition timing is repeatedly adjusted according to a result of detecting knocking, the ignition timing control advancing the ignition timing while knocking is not detected and retarding the ignition timing when knocking is detected,
automatic stop control for stopping fuel injection from a fuel injection valve when an automatic stop request is generated during operation of the internal combustion engine, and
automatic start control for resuming the fuel injection from the fuel injection valve and causing the internal combustion engine to operate when a restart request is generated while the fuel injection is stopped by the automatic stop control; and
the ignition timing control is ended when an engine rotation speed becomes equal to or lower than a first rotation speed that is more than “0”.

2. The control device according to claim 1, wherein when the ignition timing control is started by the automatic start control, control for maintaining the ignition timing at the initial ignition timing is executed without adjusting the ignition timing until a number of times of ignition reaches a predetermined number of times.

3. The control device according to claim 1, wherein control for reducing and correcting a fuel injection amount is executed when the fuel injection is resumed on condition that the automatic stop control is performed and the engine rotation speed becomes equal to or lower than the first rotation speed.

4. The control device according to claim 1, wherein:
when the ignition timing control is started by the automatic start control, control for maintaining the ignition timing at the initial ignition timing is executed without adjusting the ignition timing until a number of times of ignition reaches a predetermined number of times;
control for reducing and correcting a fuel injection amount is executed when the fuel injection is resumed on condition that the automatic stop control is performed and the engine rotation speed becomes equal to or lower than the first rotation speed; and
the control for reducing and correcting the fuel injection amount is ended when the control for maintaining the ignition timing at the initial ignition timing is ended.
